(19) United States
(12) Patent Application Publication
(10) Pub. No.: US 2025/0132412 A1
(43) Pub. Date: Apr. 24, 2025

(54) BATTERY MODULE

(71) Applicant: HONDA MOTOR CO., LTD., Tokyo (JP)

(72) Inventors: Daigo KOMATSU, Tokyo (JP); Keiji TAKEUCHI, Tokyo (JP)

(21) Appl. No.: 18/915,385

(22) Filed: Oct. 15, 2024

(30) Foreign Application Priority Data
Oct. 19, 2023 (JP) 2023-180272

(51) Int. Cl. H01M 10/653; H01M 10/613; H01M 10/655; H01M 10/6567; H01M 10/6569; H01M 50/271; H01M 50/507

(52) U.S. Cl. CPC H01M 10/653; H01M 10/613; H01M 10/655; H01M 10/6567; H01M 10/6569; H01M 50/271; H01M 50/507

(57) ABSTRACT

To allow battery cells to be efficiently cooled. A battery module includes a plurality of battery cells, at least one bus bar, and a cooling member. The bus bar electrically connects electrodes of the plurality of battery cells to each other. The cooling member contacts, in a heat transferable manner, the back side of portions of the bus bar that contact the electrodes. According to this configuration, the heat transferred from the electrodes of the battery cells to the bus bar can be dissipated to the cooling member on the back side of the electrodes. Therefore, the battery cells can be efficiently cooled.

This application is based on and claims the benefit of priority from Japanese Patent Application No. 2023-180272, filed on 19 Oct. 2023, the content of which is incorporated herein by reference.

### BACKGROUND OF THE INVENTION

### Field of the Invention

The present invention relates to a battery module including a plurality of battery cells.

### Related Art

In recent years, electric vehicles such as EVs and HEVs have become widespread from the viewpoint of reducing the emission of carbon dioxide to reduce adverse effects on the global environment. Some battery modules mounted on electric vehicles and the like each include a plurality of battery cells and a bus bar electrically connecting electrodes of the battery cells to each other.
Patent Document 1: Japanese Unexamined Patent Application, Publication No. 2006-271063

### SUMMARY OF THE INVENTION

It is an object of the present invention to efficiently cool battery cells in such a battery module.

The present inventors have found that battery cells can be efficiently cooled by bringing a cooling member into contact with the back side of portions of a bus bar that contact electrodes, and have reached the present invention. The present invention relates to battery modules according to the following aspects.

A first aspect of the present invention is a battery module including
a plurality of battery cells,
at least one bus bar that electrically connects electrodes of the plurality of battery cells to each other, and
a cooling member that contacts, in a heat transferable manner,
a back side of portions of the bus bar that contact the electrodes.

According to this configuration, the heat transferred from the electrodes of the battery cells to the bus bar can be dissipated to the cooling member on the back side of the electrodes. Therefore, the battery cells can be efficiently cooled.

In a second aspect of the present invention according to the first aspect, the bus bar includes insert receiving portions on the back side of the portions of the bus bar that contact the electrodes. The cooling member includes protrusions that are inserted into the insert receiving portions and that contact bottoms of the insert receiving portions.

According to this configuration, the cooling member can be positioned with respect to the bus bar by inserting the protrusions of the cooling member into recesses of the bus bar. In addition, the protrusions of the cooling member contact the bottoms of the insert receiving portions. Thus, the protrusions of the cooling member contact the back side of the portions of the bus bar that contact the electrodes. This allows the heat transferred from the electrodes to the bus bar to be dissipated to the protrusions of the cooling member on the back side of the electrodes.

In a third aspect of the present invention according to the first or second aspect, the cooling member includes rubber.

According to this configuration, the height variation of the bus bar can be absorbed within the elastic range of the rubber.

In a fourth aspect of the present invention according to the third aspect, the battery module further includes a case that houses the battery cells, the bus bar, and the cooling member, and
a cover that covers an opening of the case. The cooling member has a surface, on a side opposite to a side of the bus bar, in contact with the cover.

According to this configuration, the heat dissipated from the electrodes to the cooling member via the bus bar can be further dissipated to a cover. This allows the battery cells to be cooled more efficiently.

In a fifth aspect according to the third aspect, the cooling member includes rubber with heat transfer and insulation properties.

According to this configuration, the cooling member can ensure heat transfer between the bus bar and the cover, while ensuring insulation between the bus bar and the cover.

In a sixth aspect of the present invention according to the fifth aspect, the rubber is EPDM rubber.

The EPDM rubber has heat transfer and insulation properties. Thus, the EPDM rubber can ensure heat transfer between the bus bar and the cover, while ensuring insulation between the bus bar and the cover.

In a seventh aspect according to the fifth aspect, the at least one bus bar includes a plurality of bus bars. The cooling member has a part that is located between the bus bars adjacent to each other.

According to this configuration, insulation between the adjacent bus bars can be ensured by using the cooling member.

In an eighth aspect of the present invention according to the fourth aspect, the battery module further includes a water jacket provided outside the cover. A refrigerant flows between the water jacket and the cover.

According to this configuration, the heat of the battery cells dissipated from the electrodes to the cover via the bus bar and the cooling member can be further dissipated to the refrigerant. This allows the battery cells to be cooled more efficiently.

In a ninth aspect of the present invention according to the first or second aspect,
the bus bar and the cooling member have recess-protrusion shapes that allow the bus bar and the cooling member to mate with each other.

According to this configuration, misalignment of the cooling member with respect to the bus bar can be prevented. This allows the cooling member to be held in an optimal position with respect to the bus bar, thereby maximizing the heat dissipation performance. Therefore, this also allows the battery cells to be efficiently cooled.

A tenth aspect of the present invention is a battery module including
a plurality of battery cells,
at least one bus bar that electrically connects electrodes of the plurality of battery cells to each other, and
a cooling member that contacts the bus bar in a heat transferable manner. The bus bar and the cooling member have recess-protrusion shapes that allow the bus bar and the cooling member to mate with each other.

This configuration also allows the battery cells to be efficiently cooled as in the ninth aspect.

As described above, according to the invention of the first and tenth aspects, the battery cells can be efficiently cooled. Further, according to the configurations of the second to ninth aspects, which cite the first aspect, the respective additional effects can be obtained.

### BRIEF DESCRIPTION OF THE DRAWINGS

FIG. 1 is a side cross-sectional view showing a battery module according to a first embodiment, and more specifically, shows a cross section taken along line I-I in FIG. 2;

FIG. 2 is a cross-sectional view taken along line II-II in FIG. 1;

FIG. 3 is a cross-sectional view taken along line III-III in FIG. 1;

FIG. 4 is a partially enlarged view of FIG. 1;

FIG. 5 is a perspective view showing bus bars and cooling members;

FIG. 6 is an exploded perspective view showing a bus bar and a cooling member; and

FIG. 7 is a side cross-sectional view showing a battery module according to a second embodiment.

### DETAILED DESCRIPTION OF THE INVENTION

Embodiments of the present invention will now be described with reference to the drawings. However, the present invention is not limited to the following embodiments, and can be modified and implemented as appropriate within a range not departing from the gist of the present invention.

### First Embodiment

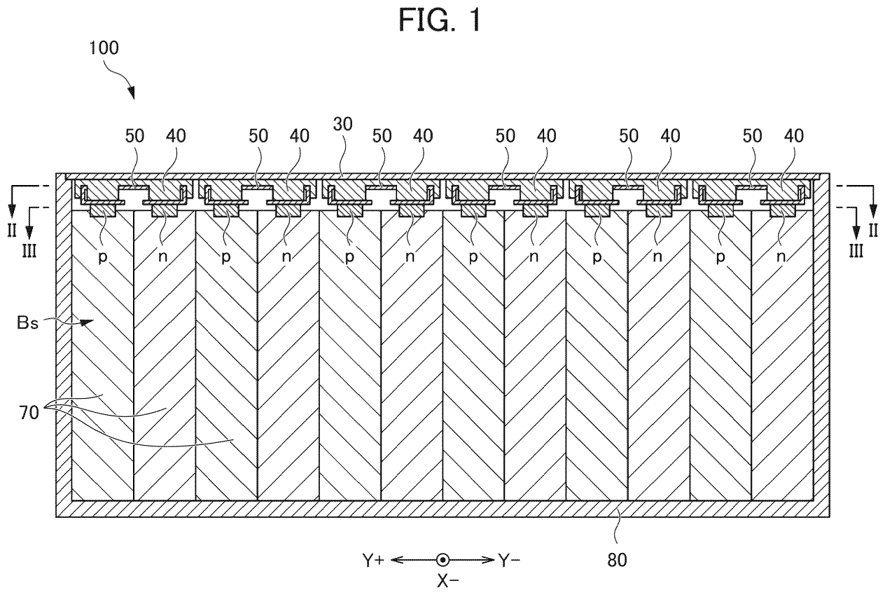

As shown in FIG. 1, a battery module 100 includes a case 80, a plurality of battery cells 70, a plurality of bus bars 50, a plurality of cooling members 40, and a cover 30.

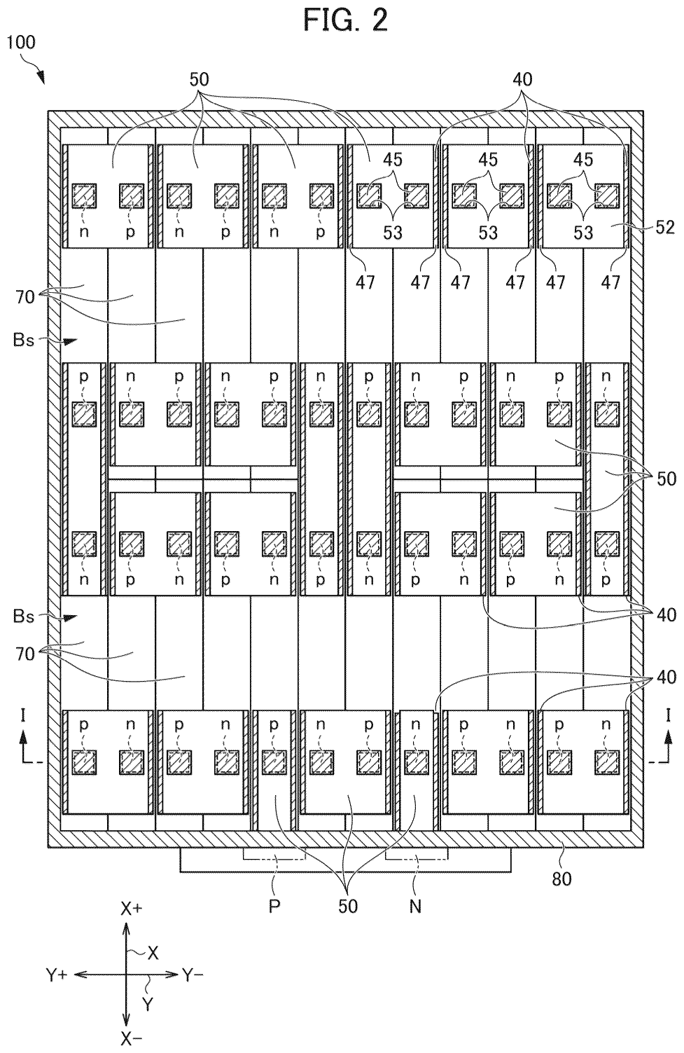

Hereinafter, as shown in FIG. 2, two predetermined directions orthogonal to each other in the horizontal plane are referred to as an “X direction” and a “Y direction”. One of the X directions is referred to as an “X− direction”, and the opposite direction is referred to as an “X+ direction”. One of the Y directions is referred to as a “Y− direction”, and the opposite direction is referred to as a “Y+ direction”.

As shown in FIG. 1, the case 80 has a box shape that opens upward. The case 80 is made of metal or the like. The case 80 houses the battery cells 70, the bus bars 50, and the cooling members 40. The cover 30 covers the opening of the case 80.

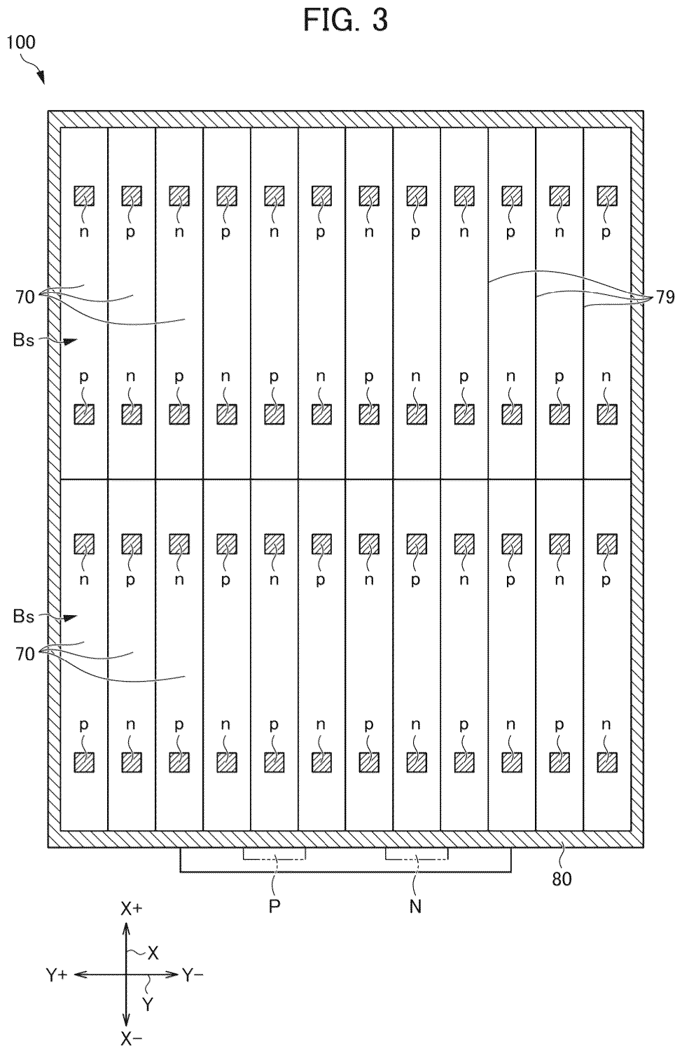

As shown in FIG. 3, each of the battery cells 70 has a rectangular exterior that is elongated in the X direction. Hereinafter, the plurality of battery cells 70 stacked in the Y direction are referred to as a “battery stack Bs”. The case 80 houses two battery stacks Bs arranged in the X direction. In each battery stack Bs, a separator 79 is disposed between battery cells 70 adjacent to each other in the Y direction. The separator 79 is made of resin or the like.

As shown in FIG. 3, each battery cell 70 includes a positive electrode p at one end in the X direction on the upper surface of the exterior, and a negative electrode n at the other end in the X direction on the upper surface of the exterior. Specifically, for a predetermined plurality of battery cells 70, the positive electrode p is disposed on the X− direction side, and the negative electrode n is disposed on the X+ direction side. On the other hand, for the other battery cells 70, the negative electrode n is disposed on the X− direction side, and the positive electrode p is disposed on the X+ direction side.

As shown in FIG. 2, most bus bars 50 electrically connect the electrodes p and n of the battery cells 70 adjacent to each other in the X direction or the Y direction. On the other hand, one predetermined bus bar 50 electrically connects the positive electrode p of the battery cell 70 on the most positive side to the positive electrode P of the entire battery module 100. Another bus bar 50 electrically connects the negative electrode n of the battery cell 70 on the most negative side electrically to the negative electrode N of the entire battery module 100. As described above, in the present embodiment, all the battery cells 70 in the battery module 100 are connected in series.

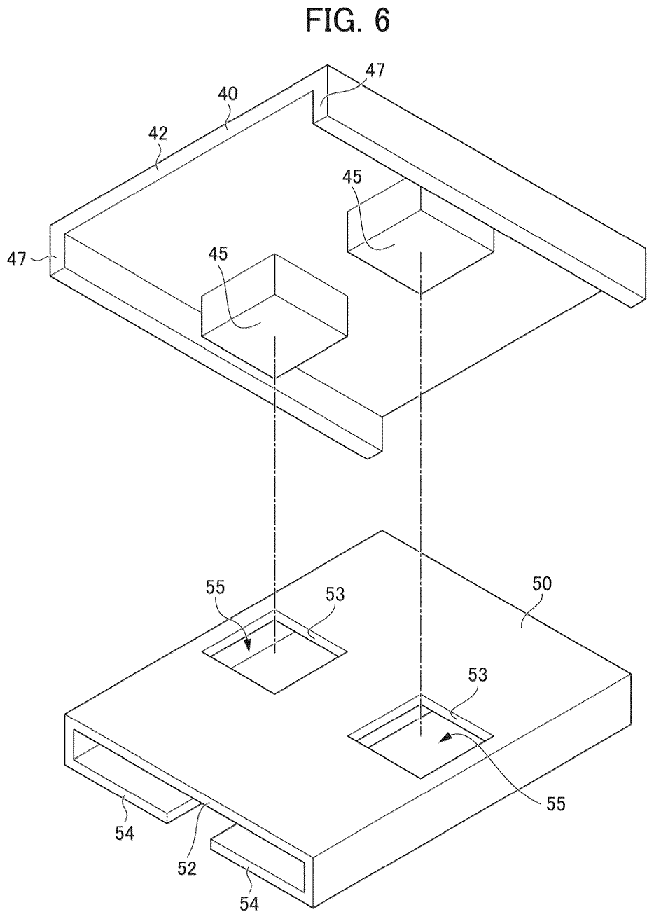

As shown in FIG. 6, each bus bar 50 is formed by, for example, bending a single metal plate. Insert receiving portions 55 are provided directly above the portions of each bus bar 50 that contact the electrodes p and n.

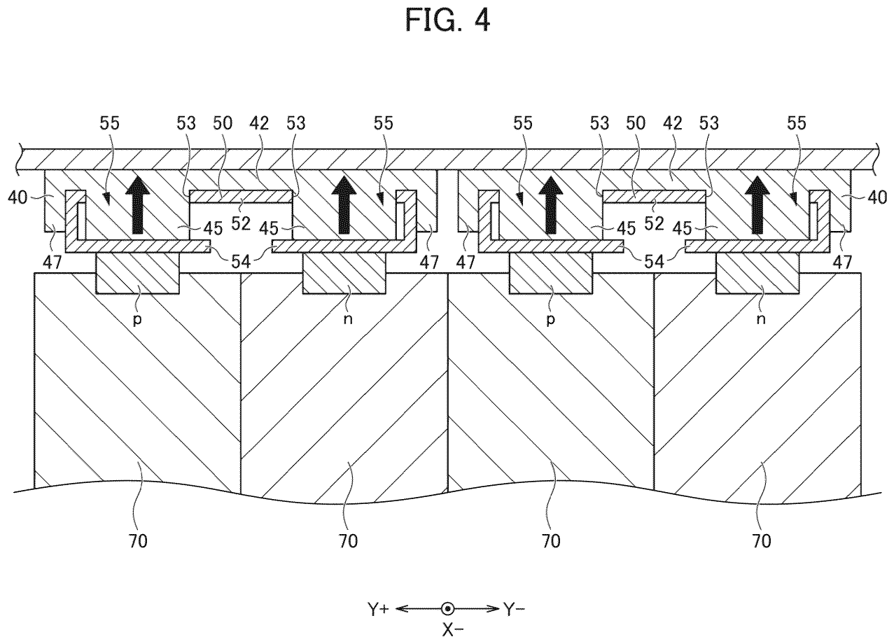

Specifically, as shown in FIG. 4, each bus bar 50 includes a bus bar base 52 and folded-back portions 54. The bus bar base 52 has a plate shape extending in the X direction and the Y direction. The folded-back portion 54 is provided for each of the electrodes p and n. As shown in FIG. 4, each folded-back portion 54 has, for example, a shape extending downward from an end of the bus bar base 52 in the Y direction and then extending inward in the Y direction, or a shape extending downward from an end of the bus bar base 52 in the X direction and then extending inward in the X direction. Those folded-back portions 54 are welded to the electrodes p, n. Through holes 53 are formed in the portions of the bus bar base 52 located directly above the electrodes p and n. The portion from the through hole 53 to the folded-back portion 54 constitutes the insert receiving portion 55. Thus, the back surfaces of the portions of the folded-back portions 54 that contact the electrodes p and n constitute the bottom surfaces of the insert receiving portions 55.

As shown in FIG. 1, the cooling member 40 is provided for each bus bar 50. Each cooling member 40 is in contact with the upper surface of the bus bar 50 corresponding to the cooling member 40 in a heat transferrable manner. Each cooling member 40 is rubber with heat transfer and insulation properties, and more specifically, is EPDM rubber (ethylene propylene diene monomer rubber).

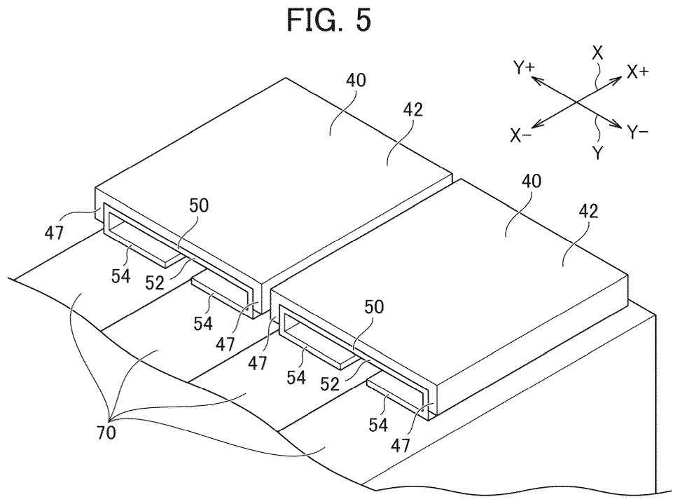

As shown in FIG. 6, each cooling member 40 includes a cooling member base 42, insulating portions 47, and protrusions 45. As shown in FIG. 5, the cooling member base 42 has a plate shape extending in the X direction and the Y direction. The insulating portions 47 protrude downward from both ends of the cooling member base 42 in the Y direction. As shown in FIG. 4, the protrusion 45 is provided for each of the electrodes p and n. Each protrusion 45 protrudes downward from the cooling member base 42. Each protrusion 45 is inserted into the corresponding insert receiving portion 55 and contacts the bottom of the insert receiving portion 55.

As shown in FIG. 5, the insulating portion 47 on the Y+ side of each cooling member 40 contacts the end portion on the Y+ direction side of the bus bar 50 from the Y+ direction side. The insulating portion 47 on the Y− side of each cooling member 40 contacts the end portion on the Y-side of the bus bar 50 from the Y− direction. Thus, the insulating portions 47, which are parts of the cooling members 40, exist between the bus bars 50 adjacent to each other in the Y direction. As shown in FIG. 4, the upper surface of the cooling member base 42 contacts the lower surface of the cover 30.

With the above configuration, as shown in FIG. 4, the heat of each battery cell 70 is dissipated from the electrode p or n to the cover 30 via the bus bar 50 and the cooling member 40.

The configuration and effects of the present embodiment will be summarized below.

As shown in FIG. 4, the cooling member 40 is in contact with the back side of the portions of the bus bar 50 that are in contact with the electrodes p and n in a heat transferable manner. Thus, the heat transferred from the electrodes p and n of the battery cells 70 to the bus bar 50 can be dissipated to the cooling member 40 on the back side of the electrodes p and n. Therefore, the battery cells 70 can be efficiently cooled.

The insert receiving portions 55 are provided on the back side of the portions of the bus bar 50 that contact the electrodes p and n. The protrusions 45 of the cooling member 40 are inserted into the insert receiving portions 55. Thus, the cooling member 40 can be positioned with respect to the bus bar 50. In addition, the protrusions 45 of the cooling member 40 contact the bottoms of the insert receiving portions 55, that is, the back side of the portions of the bus bar 50 that contact the electrodes p and n. Therefore, the heat transferred from the electrodes p and n to the bus bar 50 can be dissipated to the protrusions 45 of the cooling member 40 on the back side of the electrodes p and n.

The cooling member 40 is composed of rubber. Therefore, the cooling member 40 can absorb the height variation of the bus bar 50 within the elastic range of the rubber.

The upper surface of the cooling member 40, that is, the surface of the cooling member 40 on the side opposite to the bus bar 50 side, is in contact with the cover 30. Therefore, the heat dissipated from the electrodes p and n to the cooling member 40 via the bus bar 50 can be further dissipated to the cover 30. This allows the battery cells 70 to be cooled more efficiently.

The cooling member 40 is rubber with heat transfer and insulation properties. Therefore, the cooling member 40 ensures heat transfer between the bus bar 50 and the cover 30, while ensuring insulation between the bus bar 50 and the cover 30.

More specifically, the cooling member 40 is EPDM rubber. The EPDM rubber has heat transfer and insulation properties. As a result, the EPDM rubber ensures heat transfer and insulation between the bus bar 50 and the cover 30.

The insulating portions 47, which are parts of the cooling members 40, exist between the adjacent bus bars 50. Therefore, insulation between the adjacent bus bars 50 can be ensured by using the cooling members 40.

As shown in FIG. 6, the bus bar 50 is provided with the insert receiving portions 55. The cooling member 40 includes the protrusions 45 that are inserted into the insert receiving portions 55. That is, the bus bar 50 and the cooling member 40 have recess-protrusion shapes that allow the bus bar 50 and the cooling member 40 to mate with each other. This can prevent misalignment of the cooling member 40 with respect to the bus bar 50. This allows the cooling member 40 to be held in an optimal position with respect to the bus bar 50 as shown in FIG. 4, thereby maximizing the heat dissipation performance. Therefore, this also allows the battery cells 70 to be efficiently cooled.

### Second Embodiment

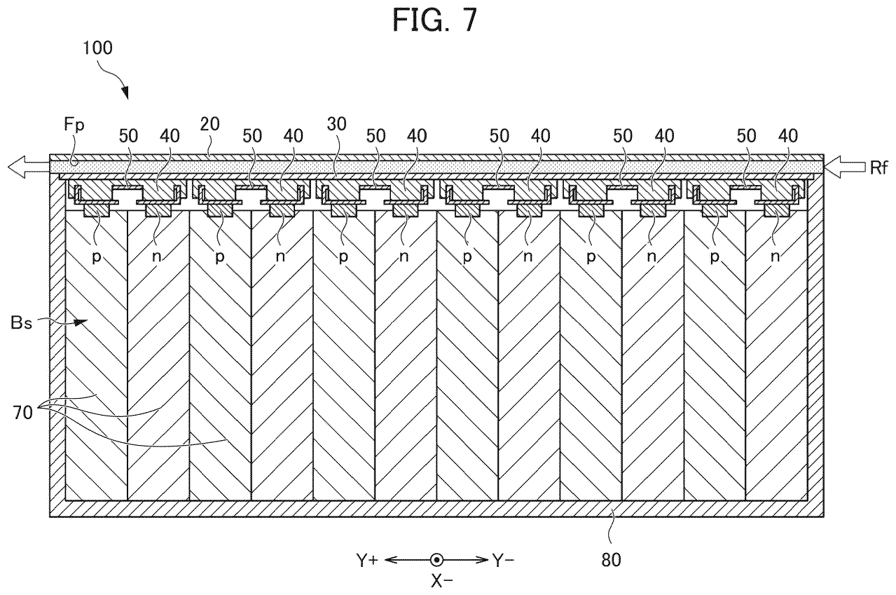

A second embodiment will be described with reference to FIG. 7. In the present embodiment, differences from the first embodiment will be mainly described based on the first embodiment, and descriptions of the same or similar points as those of the first embodiment will be omitted as appropriate.

As shown in FIG. 7, a water jacket 20 is provided above the cover 30, that is, outside the cover 30. The space between the water jacket 20 and the cover 30 constitutes a flow path Fp. A refrigerant Rf flows through the flow path Fp.

According to the present embodiment, the refrigerant Rf flows between the water jacket 20 and the cover 30. Therefore, the heat of the battery cells 70 dissipated from the electrodes p and n to the cover 30 via the bus bar 50 and the cooling member 40 can be further dissipated to the refrigerant Rf. This allows the battery cells 70 to be cooled more efficiently.

### Other Embodiments

The embodiments described above can be modified as follows, for example. The cooling member 40 shown in FIG. 4 may include rubber other than EPDM rubber. Specifically, for example, it may include silicon rubber with good heat transfer properties. The case 80 shown in FIG. 3 may house only one battery stack Bs, or may house three or more battery stacks Bs. In the case 80 shown in FIG. 2, a plurality of parallel connection bodies, each of which includes a predetermined number of battery cells 70 (e.g., two or three), may be connected in series. Some of the plurality of cooling members 40 may be integrally formed. That is, one cooling member 40 may be provided across a plurality of bus bars 50.

### EXPLANATION OF REFERENCE NUMERALS

20 water jacket
30 cover
40 cooling member
45 protrusion (recess-protrusion shape)
47 insulating portion (a part of cooling member)
50 bus bar
55 insert receiving portion (recess-protrusion shape)
70 battery cell
80 case
100 battery module
Fp flow path (between water jacket and cover)
Rf refrigerant

What is claimed is:

1. A battery module comprising:
a plurality of battery cells;
at least one bus bar that electrically connects electrodes of the plurality of battery cells to each other; and
a cooling member that contacts, in a heat transferable manner, a back side of portions of the bus bar that contact the electrodes.

2. The battery module according to claim 1,
wherein the bus bar comprises insert receiving portions on the back side of the portions of the bus bar that contact the electrodes, and
wherein the cooling member comprises protrusions that are inserted into the insert receiving portions and that contact bottoms of the insert receiving portions.

3. The battery module according to claim 1, wherein the cooling member comprises rubber.

4. The battery module according to claim 3, further comprising:
a case that houses the battery cells, the bus bar, and the cooling member; and
a cover that covers an opening of the case,
wherein the cooling member has a surface, on a side opposite to a side of the bus bar, in contact with the cover.

5. The battery module according to claim 3, wherein the cooling member comprises rubber with heat transfer and insulation properties.

6. The battery module according to claim 5, wherein the rubber is EPDM rubber.

7. The battery module according to claim 5,
wherein the at least one bus bar comprises a plurality of bus bars, and
wherein the cooling member has a part that is located between the bus bars adjacent to each other.

8. The battery module according to claim 4, further comprising
a water jacket provided outside the cover,
wherein a refrigerant flows between the water jacket and the cover.

9. The battery module according to claim 1,
wherein the bus bar and the cooling member have recess-protrusion shapes that allow the bus bar and the cooling member to mate with each other.

10. A battery module comprising:
a plurality of battery cells;
at least one bus bar that electrically connects electrodes of the plurality of battery cells to each other; and
a cooling member that contacts the bus bar in a heat transferable manner,
wherein the bus bar and the cooling member have recess-protrusion shapes that allow the bus bar and the cooling member to mate with each other.
